(19) United States
(12) Patent Application Publication
(10) Pub. No.: US 2013/0270016 A1
(43) Pub. Date: Oct. 17, 2013

(54) SOLAR ELECTRIC SCOOTER WITH REMOVABLE BATTERY MODULE

(71) Applicants: Michael C. Donnell, Van Nuys, CA (US); Tony VanMeeteren, Woodland Hills, CA (US)

(72) Inventors: Michael C. Donnell, Van Nuys, CA (US); Tony VanMeeteren, Woodland Hills, CA (US)

(21) Appl. No.: 13/730,980

(22) Filed: Dec. 29, 2012

Related U.S. Application Data
(63) Continuation-in-part of application No. 12/835,691, filed on Jul. 13, 2010.
(60) Provisional application No. 61/270,914, filed on Jul. 15, 2009.

(51) Int. Cl. B60L 8/00

(52) U.S. Cl. CPC B60L 8/003
USPC 180/2.2

(57) ABSTRACT

A solar electric scooter with a removable battery module is disclosed. According to one preferred embodiment, an apparatus is provided for transportation comprising one or more batteries capable receiving and storing an electric charge within the removable battery module. An electric motor may be capable of providing rotational velocity to one or more wheels upon receiving power from the electric batteries. A one or more photovoltaic modules may comprise solar cells capable of providing electric charge to the one or more batteries. The removable battery module is capable of being removed from the scooter and independently charged via an a/c outlet.

### RELATED APPLICATION INFORMATION

This Application is a continuation-in-part of U.S. application Ser. No. 12/835,691, filed Jul. 13, 2010, entitled SOLAR ELECTRIC SCOOTER, which claims priority from U.S. Provisional Patent Application Ser. No. 61/270,914, entitled SOLAR ELECTRIC TWO WHEEL SCOOTER, filed Jul. 15, 2009.

### FIELD OF THE INVENTION

A solar electric transport apparatus is disclosed. Specifically, a solar electric apparatus has foldable solar modules, allowing for protection of such modules during use of the apparatus, and easy solar charging or A/C plug-in charging during non-use of the apparatus.

### BACKGROUND OF THE INVENTION

Presently, many forms of transportation may use pollution-emitting forms of power, including internal combustion engines, and the like. Most vehicles use non-renewable resources, such as gasoline, to power those vehicles.

Many solutions have been tried, but have failed. For example, solar powered vehicles have failed because of the lack of horsepower and the need for sunlight during operation. Further, the panels that hold the solar cells have mostly proven to be too large for aerodynamics, and are cumbersome in terms of vehicle design. Further, these prior art panels have suffered the shortcoming of a lack of sufficient surface area to replenish used up charge in a reasonable amount of time.

None of the above prior devices allow for maximized solar cell area while allowing for aerodynamic storage of such cells during use of the vehicle. Thus a solar electric vehicle solving the aforementioned problems is desired.

### SUMMARY OF THE INVENTION

In order to solve the problems and shortcomings of the prior art, a solar electric transport apparatus with foldable solar cells is disclosed. According to one preferred embodiment, an apparatus is provided for transportation comprising one or more batteries capable of receiving and storing an electric charge. An electric motor may be capable of providing rotational velocity to one or more wheels upon receiving power from the electric batteries. A plurality of foldable photovoltaic modules may comprise solar cells capable of providing electric charge to the one or more batteries.

According to a preferred embodiment, the apparatus may comprise a scooter, having a frame. The foldable modules may form a deck on which an operator of the scooter can place feet when the modules are in a folded configuration. The solar cells may be capable of exposure to light radiation when the foldable modules are in an unfolded configuration.

According to another preferred embodiment, the foldable modules may be located anywhere on the scooter or transportation apparatus. For example, the foldable modules may be located on the bottom a scooter, wherein the user would turn the scooter upside down to unfold and expose the modules to light radiation above.

According to another preferred embodiment, the apparatus may comprise a switch for electrically connecting the foldable modules to the batteries for charging. The switch may be manually operated by the operator. In another preferred embodiment, the switch may be mechanically operated by the unfolding of the solar modules. In yet another preferred embodiment, a soft switch may cause the foldable modules to electrically connect to the batteries upon detection of electrical current from foldable modules. In one preferred embodiment, the switch may prevent operation of the scooter when the foldable modules are electrically connected to the batteries.

According to another preferred embodiment, the photovoltaic modules may comprise thin solar cells that are rolled instead of folded during operation of the transportation apparatus. For example, when a scooter is not in operation, rolled-up modules may be unrolled on the sides of the scooter to lay flat along the ground or over the handlebars to offer maximum light exposure during solar charging.

In another preferred embodiment, a method for retrofitting an existing scooter may comprise providing two or more foldable photovoltaic modules comprising solar cells capable of providing electric charge to one or more batteries; connecting the one or more photovoltaic modules to the one or more batteries; and unfolding the one or more photovoltaic modules to expose the solar cells to light radiation, thereby charging the one or more batteries.

### BRIEF DESCRIPTION OF THE DRAWINGS

FIG. 1 is a left-front perspective view of the a scooter according to one embodiment of the invention with photovoltaic modules having solar cells folded in a position for operation of the scooter;

FIG. 2 is a left-front perspective view the scooter of FIG. 1 with the photovoltaic modules with solar cells partially extended as they are being unfolded to a position for solar charging of the scooter;

FIG. 3 is a left-front perspective view the scooter of FIG. 1 with the photovoltaic modules with solar cells fully extended for charging;

FIG. 4 is an electrical schematic of the charging system for the scooter of FIG. 1;

FIG. 5 is an alternative electrical schematic of the charging system for the scooter of FIG. 1;

FIG. 6 is yet another alternative electrical schematic of the charging system for the scooter of FIG. 1;

FIG. 7 is a flow diagram illustrating steps for retrofitting an existing scooter according to one embodiment;

FIG. 8 is a side perspective view showing details of a chassis according to an alternative embodiment;

FIG. 9 is a side perspective view showing details of the front and middle of the chassis according to the embodiment of FIG. 8;

FIG. 10 is a rear perspective view of the scooter that shows details of one embodiment of a rear of the chassis according to the embodiment of FIG. 8;

FIG. 11 is a rear perspective view of the scooter that shows details of an alternative embodiment of a rear of the chassis according to the embodiment of FIG. 8;

FIG. 12 illustrates components of the electrical drive system according to the embodiment of FIG. 8; and

FIG. 13 illustrates further various components of an electrical system according to the embodiment of FIG. 12; and

FIG. 14 illustrates a scooter according to the embodiment of FIG. 8 with an alternative roll-out solar cell module.

### DETAILED DESCRIPTION OF THE PREFERRED EMBODIMENTS

For the purpose of illustrating the invention, there is shown in the accompanying drawings several embodiments of the invention. However, it should be understood by those of ordinary skill in the art that the invention is not limited to the precise arrangements and instrumentalities shown therein and described below.

According to one embodiment, a solar-chargeable apparatus, such as a scooter, provides low cost transportation by virtue of the fact that it is receiving electrical power from the sun. The scooter may be of low cost to purchase because it is designed and constructed from readily available, materials. Further, the scooter may be fun to operate, and the fact that the scooter is powered by solar energy gives its owner the opportunity to contribute to the well being of the environment and reduce emissions harmful to humans.

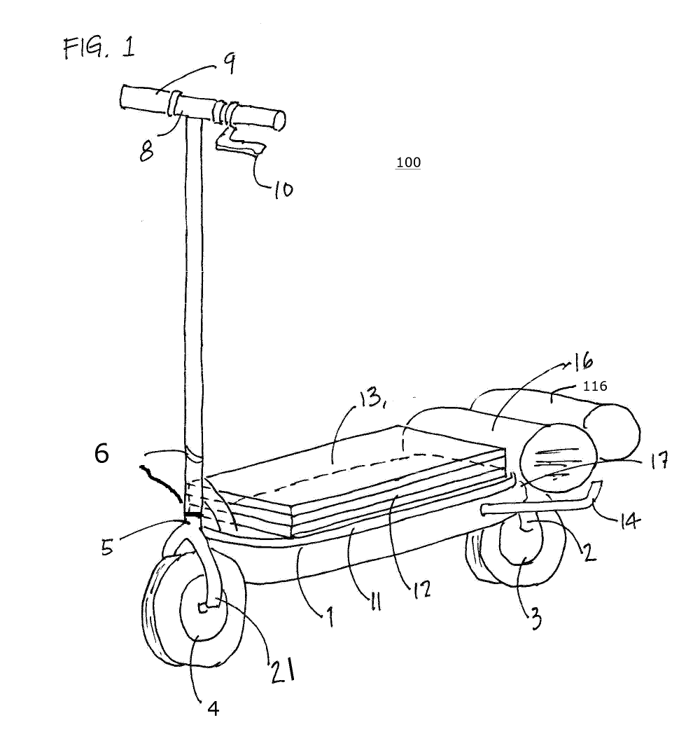

With reference to FIG. 1, a left-front perspective view of a scooter 100 is shown according to one embodiment, with photovoltaic modules 12 folded in a position for operation of the scooter 100. A frame or chassis 1 of the scooter 100 may be comprised of various types of metal or plastic, and horizontally situated. A front fork 21 steerably attaches to the frame 1 and holds a front wheel 4 in place. A rear fork 2 attaches a rear wheel 3 to the frame by horizontal axles mounted between the forks 21 and 2.

At the front of the chassis 1, an elongated metal or plastic steering column 5 may be attached to the front fork 21. In other embodiments, the frame 1, and column 5 may be made of any suitable material such as aluminum or carbon fibre for lightness and strength.

The steering column 5 may rotate with respect to the frame by means of a head tube assembly 6 attached to the chassis 1. In one embodiment the head tube assembly 6 is similar to that on a bicycle as those of skill in the art would recognize. The rider may turn the scooter while operating by rotating the steering column via a handlebar 8. In some embodiments, a telescoping steering column 5 may allow for adjustment of the handlebar 8 to different heights. In one embodiment, the steering column may be hinged with a locking and release device near its lower extremity so that it folds into a horizontal position to facilitate ease of transport.

A throttle 9 may be mounted on the right side of the handle bar 8, and a hand brake lever 10 on the left side. The throttle 9 may be a variable speed twist grip or thumb/finger activated variable speed device.

The hand brake lever 10 may operate a brake attached to the rear wheel. In other embodiments, a front and rear brake is provided, with the rear operated by a foot pedal, and the front operated by the break lever 10.

A deck 11 may sit horizontally astride the middle of the chassis 1. The deck 11 may comprise one or more photovoltaic modules 12 that may be hinged to expand and increase their size to provide a greater exposure of surface to the sun when the scooter 100 is not in use. A photovoltaic module 12, may comprise, for example, and not by way of limitation, a module 12 comprising a cluster of one or more solar cells commonly known to those in the art that convert light radiation into electric current. When the photovoltaic modules 12 are folded into the stowed position (closed as shown in FIG. 1), the operator may stand on the exposed underside of the top photovoltaic module 12. The photovoltaic modules 12 may be connected together by wires and also to a battery 116 for the transmission of electricity from the photovoltaic modules 12 to the battery 116. In some embodiments, one or more batteries 116 may be located in various locations depending on the scooter model; for example, in the front of the frame 1, under the photovoltaic modules 12, or at the rear of the scooter 100 as shown in FIGS. 1-3.

When the photovoltaic modules 12 are in the stowed position, as shown in FIG. 1, the underside 13 of the top stowed photovoltaic module 12, on which the user may stand during operation, may comprise a non-slip material so that the user does not slip. In one embodiment, the photovoltaic module 12 on top of the folded stack may be covered with a clear material with solar cells 42 exposed on the underside, thereby providing charging while the modules 12 are in the folded position.

It should be understood that the photovoltaic modules 12 may be alternative located in one or more of several areas on the transportation apparatus or scooter 100. For example, instead of forming a deck on top of the frame 1 of the scooter 100, the photovoltaic modules 12 may be folded underneath the frame of scooter 100. For example, for charging, the modules 12 may unfold from underneath the scooter 100, or the whole scooter 100 may be turned upside down to unfold and expose the solar cells 42 on the modules to light from above.

In one embodiment, a kickstand 14 is included that may be extended to hold the scooter in an upright position while parked.

In one embodiment, the rear 17 of the chassis 1 houses an electric motor 16 and one or more batteries 116. The drive system for the scooter 100 may include a system known to those skilled in the art that provides a drive mechanism for the rear wheel 3. For example, the rear wheel 3 may be attached to the electric motor 16 by means of a belt, chain or gear that transmits rotational power from the motor 16 to the rear wheel 3. The amount of power delivered to the rear wheel 3 by the motor 16 may be modulated by the user by means of the throttle 10 on the handlebar 8. Alternatively, as described below, a hub motor may be employed.

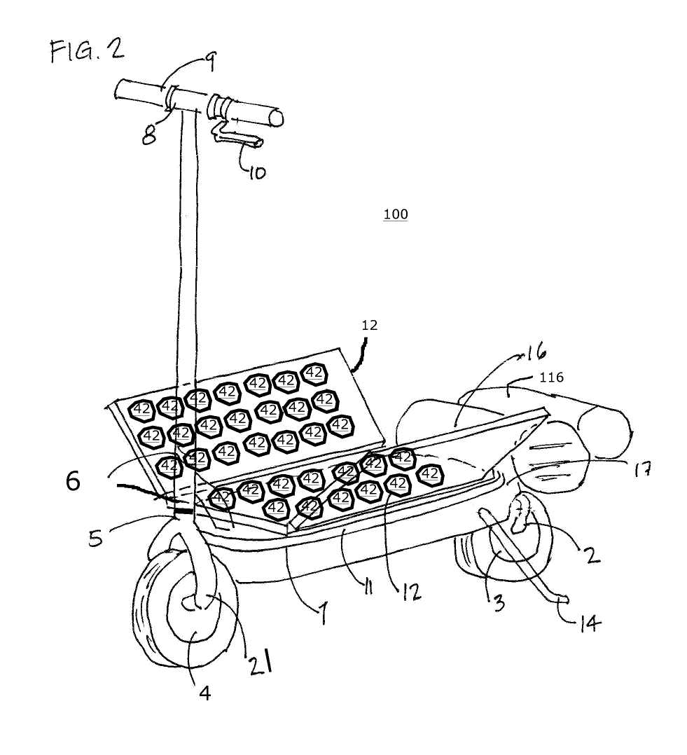

With reference to FIG. 2, a left-front perspective view the scooter 100 of FIG. 1 with the photovoltaic modules 12 partially extended as they are being unfolded to a position for solar charging of the battery(ies) 116 of the scooter 100 is shown. In one embodiment, the batteries 116 may be charged by light radiation (from the sun or otherwise). A photovoltaic electricity generation cells (solar cells) 42 may be located on the inside-top of the photovoltaic modules 12.

In some embodiments, there may be one photovoltaic module 12 or numerous modules 12, with solar cells 42 attached to the inside-top to facilitate the generation of more electricity. If there are numerous modules 12, they may be connected by wires for the continuous transmission of electric charge to the battery 116.

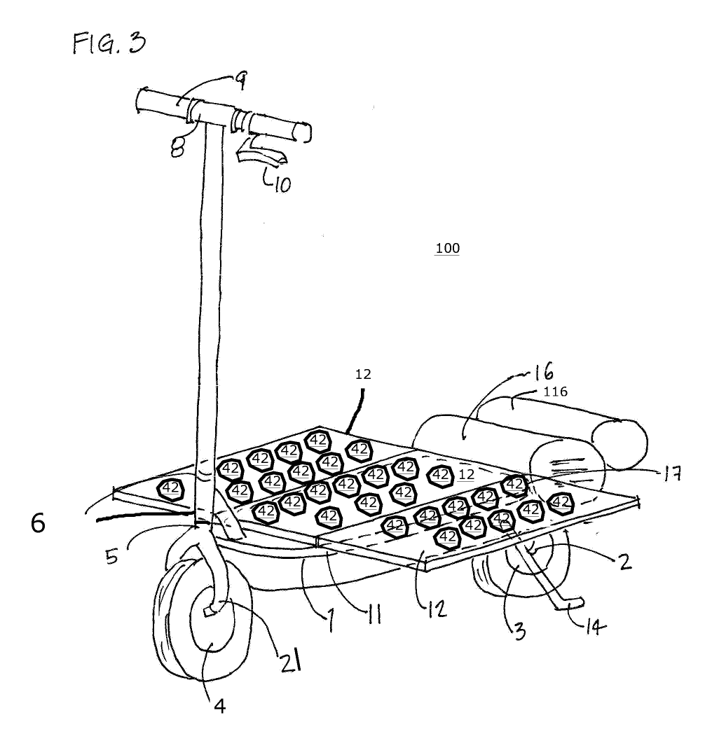

With reference to FIG. 3, a left-front perspective view the scooter 100 of FIG. 1 with the photovoltaic module 12 with solar cells 42 fully extended for charging is shown. In one embodiment, in order for the photovoltaic modules 12 to generate electric charge for the battery 116, the scooter may be placed in the parked position. This is when the photovoltaic modules 12 may be fully extended in their solar charging position as shown in FIG. 3.

In some embodiments, the size and number of the photovoltaic modules 12 may vary, and may be changed from time to time to allow for the generation of additional electrical power to be provided for increased range and time-of use of the scooter 100. The photovoltaic modules 12 may comprise a flat module 12, including a concentrating photovoltaic module 12 on top of the frame 1 or deck, or they may comprise a number of photovoltaic modules 12 that are hinged together and are deployed when the scooter is in the charging position as shown in FIG. 3.

In one embodiment, instead using rigid modules 12, the photovoltaic modules 12 may comprise thin solar cells that may be rolled during storage, and unrolled for solar charging of the scooter 100. For example, rolled-up thin photovoltaic modules 12 may be rolled on or under the deck of the scooter 100, on the side of the scooter 100, on the back, underneath, or even from the handlebar 8 of the scooter 100.

In other embodiments, the scooter 100 may also receive electricity from additional sources. For example, by way of example and not by way of limitation, the scooter 100 may additionally connect to stand alone solar modules not attached to the scooter 100, or a plug in a/c charger may be provided for plug-in charging or charging during night or inclement weather.

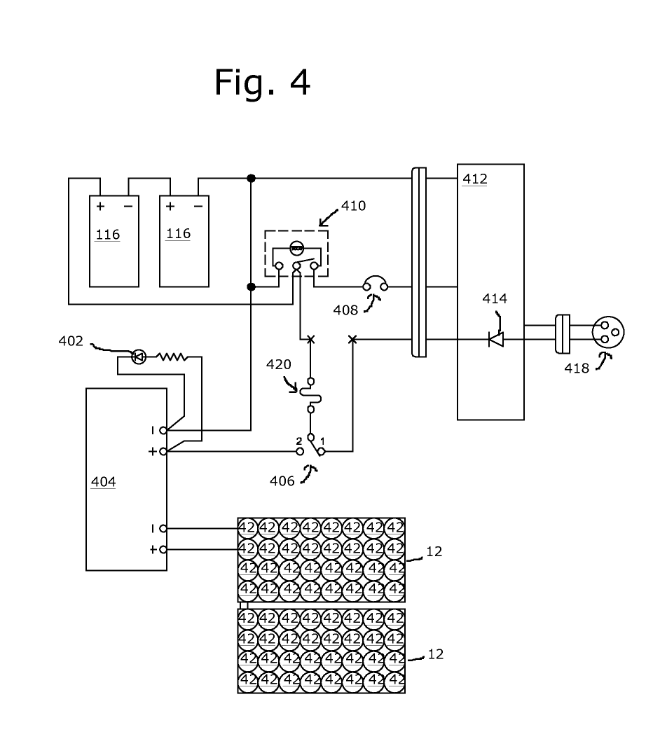

With reference to FIG. 4, an electrical schematic of the charging system for the scooter 100 of FIG. 1 according to one embodiment is shown. As stated above, there may be several methods by which the batteries 116 of the scooter 100 may be charged. The photovoltaic modules 12 with solar cells 42 may be electrically connected to a solar controller 404, that regulates electrical current form the photovoltaic modules 12. When power is being received by the solar controller 404, a light emitting diode (LED), which is electrically connected to the solar controller 404, is lit. A negative, or ground, lead may be connected to the ground, or negative lead side of the batteries 116. However, the positive lead from the solar controller 404 may be routed to a switch 406 mounted on the steering column 5 or handlebar 8. In one embodiment, this switch 406 may be activated manually by the user when the photovoltaic modules 12 are unfolded for solar charging of the batteries 116.

After the switch 406, the positive lead is routed through a fuse 420 to an on/off switch 410 for operation of the scooter 100. In this respect, when the switch 410 is in the on position for operation of the scooter 100 by the user, then the solar modules 12 may not be used to charge the batteries 116. Thus, the positive lead is cut off by the switch 410 when the on/off switch 410 is in the operating position for the scooter 100.

In the embodiment of FIG. 4, a charging port 418 for a/c plug-in charging is further provided. The switch 406 mounted on the steering column 5 may be put into a plug-in charge position to charge via the plug-in a/c charging port 418 instead of the modules 12. On a scooter control circuit board 412, a reverse polarity protection diode 414 provides for single direction current through the positive lead. The negative lead from the plug-in a/c charging port 418 is routed through the scooter's circuit breaker 408 to prevent overloading damage to the scooter's electronics during plug-in charging.

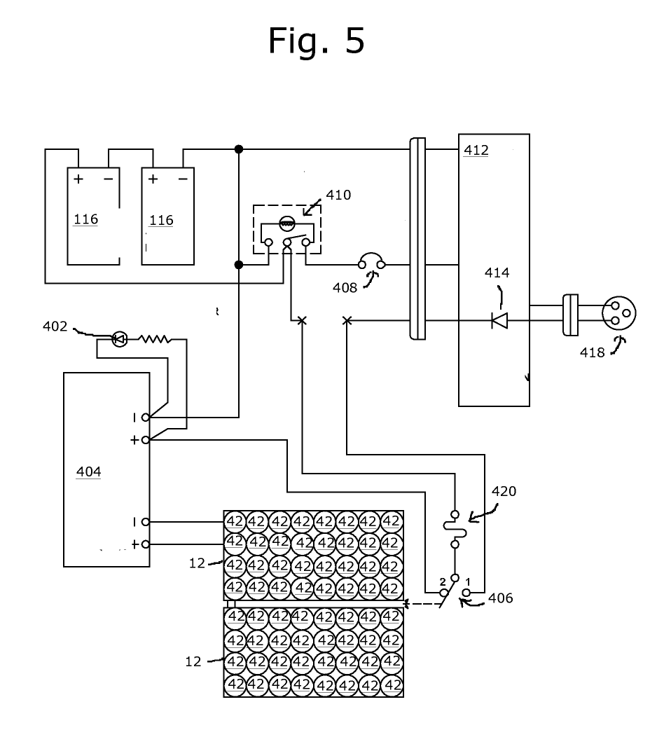

With reference to FIG. 5, an alternative electrical schematic of the charging system for the scooter of FIG. 1 is shown. The switch 406 may be activated by opening of the photovoltaic modules 12, and deactivated by closing of the modules 12.

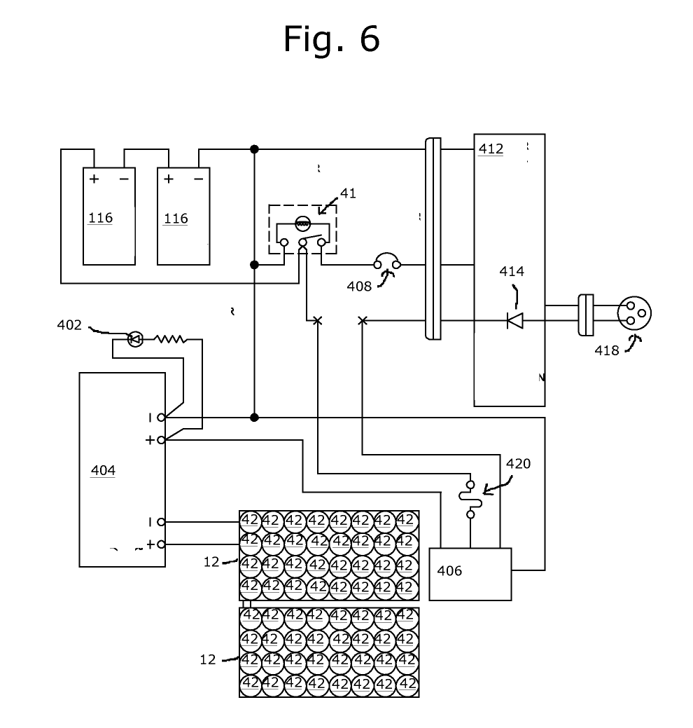

With reference to FIG. 6, yet another alternative electrical schematic of the charging system for the scooter of FIG. 1 is shown. In the Embodiment of FIG. 6, the switch 406 comprises an electronic soft switch that is activated upon detection of current from the photovoltaic modules 12 or by the solar controller 404 to direct charging of the batteries from the photovoltaic modules 12 instead of the a/c charging port 418.

In one embodiment, existing scooters may be modified using a retrofit kit to convert it into a solar charging scooter. The bottom photovoltaic module 12 in the stack may have integrated brackets that facilitate the attachment of the stack of photovoltaic modules 12 to the deck of an electric scooter 100. In some embodiments, the brackets may be pre-measured and mounted on the bottom module 12 so that they are situated to fit existing screw holes in existing models of scooters 100.

The bottom photovoltaic module 12 may have a frame around its perimeter that, when attached to the scooter 100, holds the module 12 above the scooter frame 1, forming a cavity between the bottom of the photovoltaic module 12 and the top of the scooter frame 1. This cavity may contain following sub-parts: the solar controller 404; the switch 406 that is integrated into the frames of the modules 12, and that activates the solar controller 404 when the modules 12 are unfolded to accept sun light; the fuse 420; and the LED 402, which may be installed in the outer frame of the bottom module 12. Wires may be extended from under the bottom photovoltaic module 12 that are used to connect to the electrical circuitry inside the scooter battery compartment.

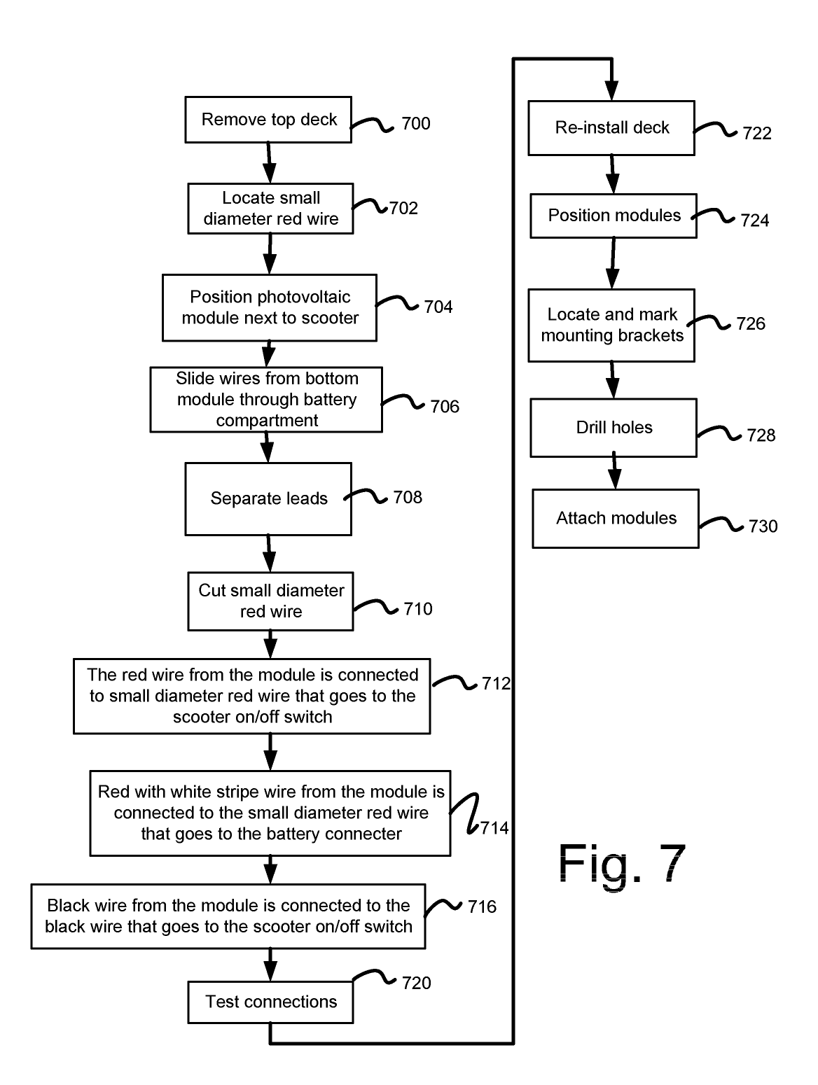

With reference to FIG. 7, a flow diagram illustrates a method of connecting the retrofit kit to an existing or prior-art scooter 100. A retrofit kit can be installed using the following minimum tools: phillips screwdriver, blade screwdriver, pliers, wire cutters, and an ohmmeter.

In step 700, the top deck of the scooter 100 being retrofitted is removed, exposing or opening the battery compartment. In step 702 the user may locate the small diameter red wire connected at one end to the scooter on/off switch. In step 704, the photovoltaic modules 12 are positioned next to the scooter 100. In step 706, the wires that extend from under the bottom photovoltaic module 12 are pulled out and slid through a hole in the side of the battery compartment. In step 708, the wire leads are separated. In step 710, in the scooter battery compartment, the small diameter red wire is cut. In step 712, the red wire from the module is connected to the small diameter red wire that goes to the scooter on/off switch. In step, 714, the red with white stripe wire from the module is connected to the small diameter red wire that goes to the battery connecter. In step 716, the black wire from the module is connected to the black wire that goes to the scooter on/off switch. Quick connection wire connectors may be supplied so that the wires do not need to be stripped to be connected. In step 720, the connections are tested using the ohmmeter. In step 722, the deck of the scooter is re-installed and screwed into place. In step 724, the modules are positioned on top of the scooter deck. In step 726, the mounting brackets are located and marked in the scooter deck where the holes in the brackets contact the scooter deck. In step 728, ⅛ inch holes are drilled in the scooter deck. In step 730, using the screws that are inserted into the holes made in the deck to attach the photovoltaic modules 12.

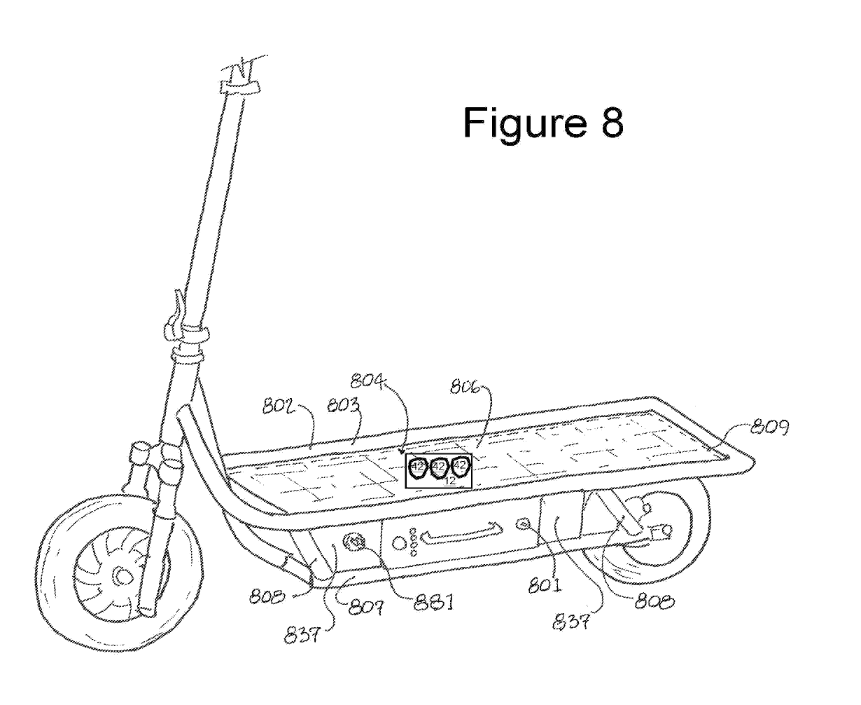

With reference to FIG. 8, details of a chassis are shown according to an alternative embodiment. In one embodiment, there may be a key lock 801 to the ignition of the scooter and the key lock 801 may be mounted on many possible locations on the scooter 802. An alternative frame 802 that may be used as the primary structure of the scooter. The material may comprise a rod, bar, pipe or tube. The upper frame 802 may be of various strength aluminum alloys, steel alloys, stainless steel or plastics. The materials of the upper frame 802 may be of various wall thicknesses and tube widths. The dimensions of the upper frame 802 may meet or exceed standard specifications.

A top tube 803 of the scooter upper frame 802 may form a rectangle that supports the deck of the scooter which may support one or more solar electric modules 12 having solar cells 42, (photovoltaic, (PV) modules). The solar modules 12 may be laminated and secured to the deck of the scooter. In one embodiment, the solar modules 12 may have a glass surface 806 with a non-slide texture embedded in the glass that may help prevent the rider from slipping off the platform or deck 804 while riding. Further, the solar modules 12 may be laminated with scratch resistant, shatter resistant, non-skid specialty glass in various thicknesses. Further, the solar modules 12 may be laminated to many different materials or polymers for rigidity.

Solar modules 12 may be made up of monocrystalline silicon cells 42, poly crystalline, thin film amorphous or any combination of the available panel options at the time of manufacturing. The type of solar module 12 is not limited and could include a concentrated solar module. Where there are numerous solar modules 12 on the scooter, some may or may not have glass laminated to them. One or more solar modules 12 may be mounted under the scooter so once the scooter is flipped upside down, the solar modules will be exposed to the sun light. The solar module 12 may be of the thin film type which could be rolled up on the scooter and subsequently unrolled and exposed to the sun. The solar modules 12 may be stored in a storage box or bag 880 on the scooter and unfolded to be exposed to the sun to charge the scooter.

In one embodiment, the primary charging of the scooter batteries may be from standard 110/120v ac power supply through a socket 881. The electricity from the solar module(s) 12 may augment or add to the charging of the batteries from the standard 110/120 volt AC power supply.

The deck 804 of the scooter that sits within the tubular frame may be fabricated of many substrates or materials, including but not limited to, plastic, honeycomb, aluminum or steel.

The lower frame 807 of the scooter, made of the same materials as the upper frame 802. This lower frame 807 may provide additional support for the scooter rider and also provide a platform for container that holds various electrical components of the scooter. The upper frame and the lower frame may be attached with various vertical or diagonal braces 808 attaching the two frames. On the inside edge of the upper frame 802 a lip or bracket 809 may be attached to support the deck 804 made of various substrates including solar modules.

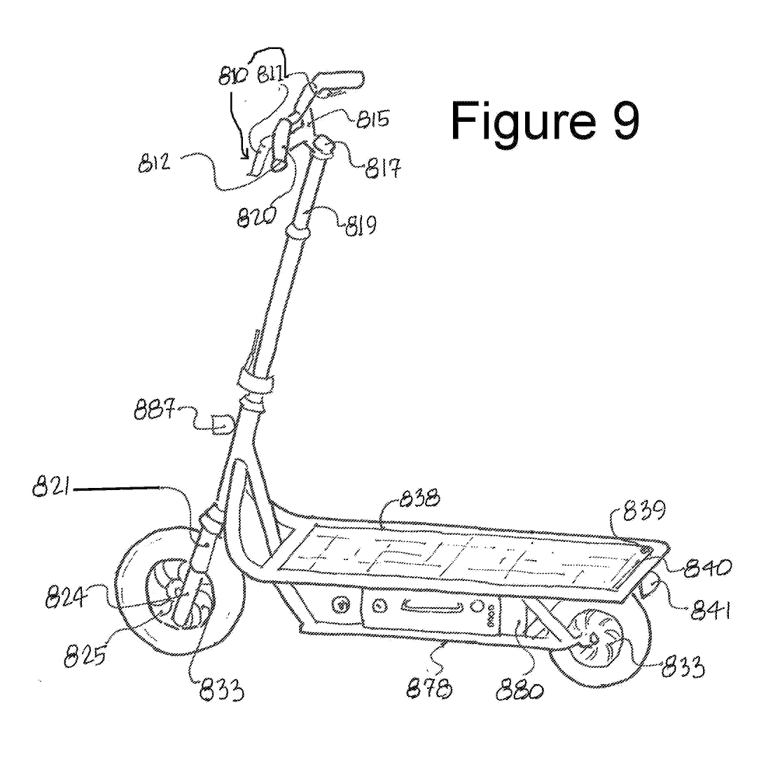

With reference to FIG. 9, a side perspective view shows details of the front and middle of the chassis according to the embodiment of FIG. 8. There may be one or two hand brakes levers 810 mounted on the handlebars 812, one for the front wheel and another for the rear wheel. There may be power modulators 811 connected to the hand brake levers 810 that send a signal to the power controller when the brakes are applied. The brake levers 810 may be made of a metal alloy, other metals or plastic. The handlebars 812 may have various additional items installed on them; such as, but not limited to, on/off switches, key locks, front and rear lights, horns and turn signals, as those skilled in the art would recognize. As those of skill in the art would further recognize, there may also be other alternate power controls and sources mounted on the handlebars 812. These may include alternate power adaptors/chargers electrically powered devices, including, but not limited to: USB powered devices such as phones, mp3 players. As technology changes the ports will change along with the needs of the rider. These additional lights and devices may be powered by the scooter batteries, a separate solar panel or self-contained batteries.

The handle bars 812 may be manufactured of various materials such as, but not limited to aluminum, aluminum alloys, steel alloys, stainless steel, carbon fiber or plastics. The handlebars 812 may be finished in various colors, anodized metals or painted. The handlebars 812 may have a separate post clamp 815 attaching it to an upright post 819 that may be adjustable for different heights of riders. The handlebars 812 may come in many shapes and lengths. Handlebars grips 820 may be different types, sizes and be made of many available materials.

The front forks 821 may be made of a plurality of materials such as but not limited to aluminum alloy, steel, plastic or magnesium. The front forks 821 may have various types of shock absorbers 824 installed on them, including, but not limited to; spring loaded, pressure systems or adjustable preload shocks. The front forks 821 may come in various colors. The front forks 821 may accept many different types of brakes, including, but not limited to, v-brakes or disk brakes 825. The front forks may accept a hub motor 825 which may be electrically connected to the power controller.

With reference back to FIG. 8, as stated above, the top deck 804 may have one or more solar modules 12 installed on it. However, there may be numerous solar modules 12 that fold under or are adjacent to each attached to the deck 804 of the scooter as illustrated in FIGS. 2-3. Alternatively, or in addition, the top deck solar modules 12 may be fixed and several other solar modules may slide out from under the upper deck 804 module 12 to form a larger array. Still further, one or more solar modules 12 may be stored under the deck 804, may be lifted up in order to pull out additional panels or unfolded in a manner shown in FIGS. 2-3. Finally, instead of folding or sliding out, the solar modules 12 may be stored under the bottom 878 of the scooter and then pulled out and attached or plugged in to the top solar module 12 to form a larger solar array to allow a faster charging period.

Brakes 833 may be disc, drum or v-type. The brakes 833 may be installed to apply braking force to the front wheel and/or the rear wheel.

There may be one or multiple metal or plastic boxes or/containers 837 mounted on the chassis under the solar modules 12. These boxes 837 may contain, by way of example and not by way of limitation, batteries, controllers, chargers, solar controllers, any electrical circuitry needed for the operation of the battery or electronics, and many other support devices to the scooters operation.

Where the solar modules 12 connect to the upper frame 802 of the chassis, the joint may be sealed with a liquid or semi-liquid sealant or a solid or pliable gasket 838.

The solar modules 12 may be connected by bolts and nuts or screws 839 where the solar modules 12 attach to the upper frame 802 of the scooter. Further, the solar modules 12 may be mounted or connected to the upper frame 802 of the scooter by inserting the modules 12 under a metal lip 840 that is attached to one edge of the upper frame 802 and installing a removable metal lip on the opposite or adjacent edge of the frame. Such removable lip may be attached to the frame with screws or other attachment devices.

Safety reflectors 841 may be mounted on various locations on the scooter front, back and sides.

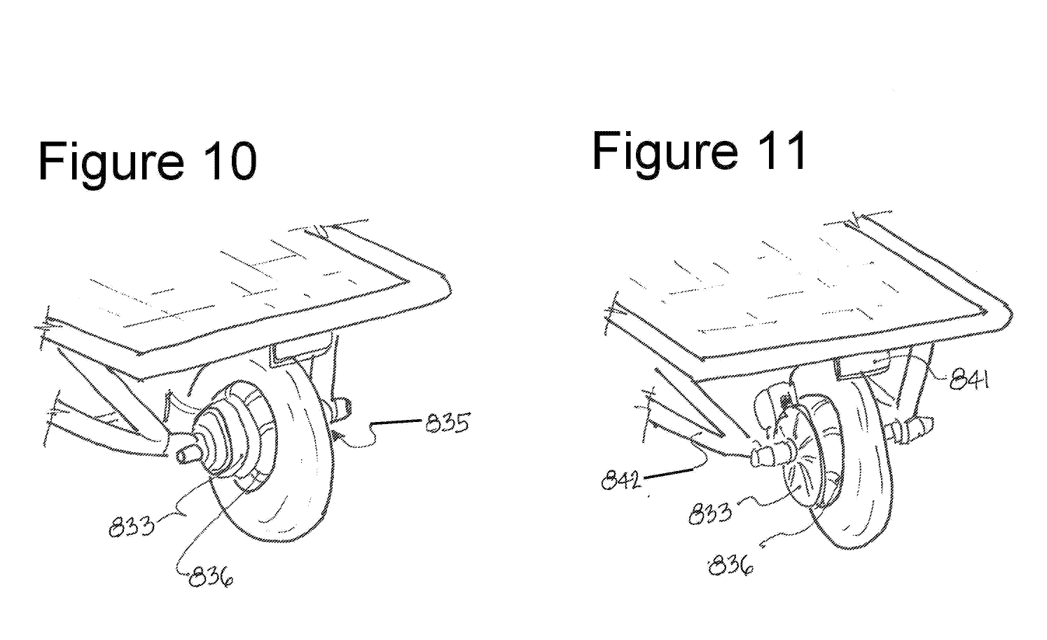

With reference to FIG. 10, a rear perspective view of the scooter shows details of one embodiment of a rear of the chassis according to the embodiment of FIG. 8. Electric motors 835 may be installed on the scooter in various locations and connected to either the front or rear wheels with a chain, belt or drive shaft. The motors 835 may range from 100 to over 1000 watts, brushed or brushless. Alternatively, electric motors 836 may be embedded into the front or in the rear wheel hub, which are called hub motors 836 to those of skill in the art.

With reference to FIG. 11, a rear perspective view of the scooter shows details of an alternative embodiment of a rear of the chassis according to the embodiment of FIG. 8. The rear forks 842 may accept the standard wheel set with a disk 833 or band brake system. In one embodiment, The rear forks may accept a hub motor 836 when installed in the back of the scooter.

Further, the rear forks or frame may contain one or more shocks absorbers.

Further, the rear chassis may be configured to allow for easy swap out of the hub motor wheel. The location of the rear wheel with regard to the scooter frame may vary. It may be positioned more forward or backward depending on the scooter model and configuration. Further, the rear wheel tire size may be of many different sizes in height and width. When a brushed or brushless electrical motor is used to drive one of the wheels of the scooter, there may be a sprocket that uses a chain system which may come in various sizes. In lieu of a sprocket and chain system a drive belt system may be used. The motor may drive various sizes and combinations of sprockets, teeth and width of chains. When various wattage hub motors 836 are used, the electrical cable may be secured where it enters the control panel and the frame.

In one embodiment, the scooter may be equipped with a permanent or removable seat. The scooter also may have a permanent or removable basket that may or may not fold up to store away on or in the scooter.

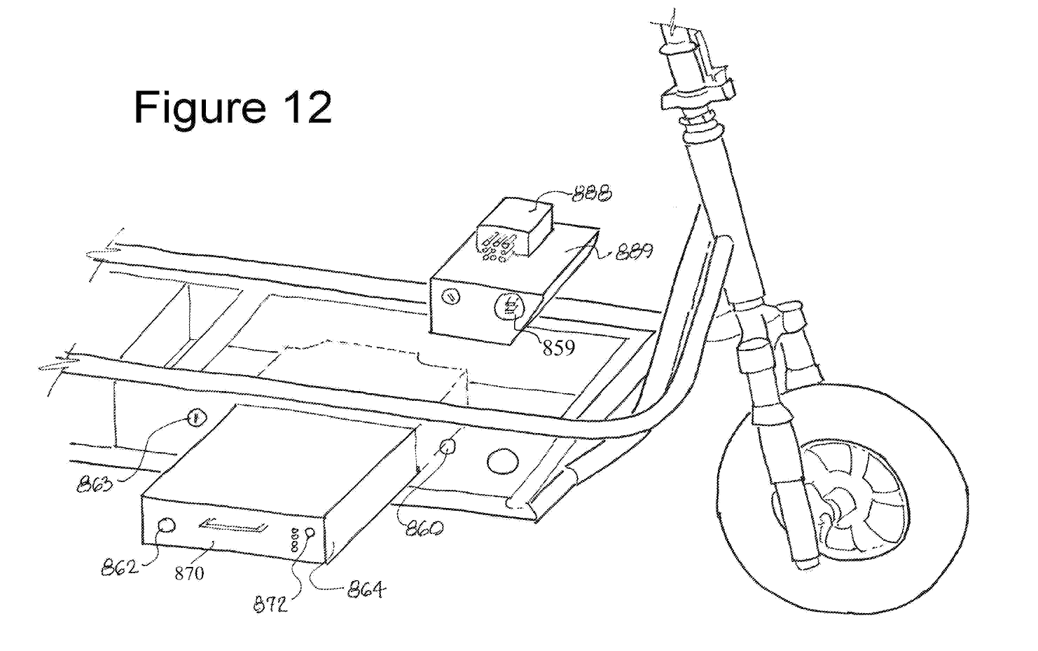

With reference to FIG. 12 components of the electrical drive system are shown. A direct current (DC) electric motor (i.e., 836 above) may be brushed or brushless. The electric motor may be an alloy DC earth magnet brushed motor.

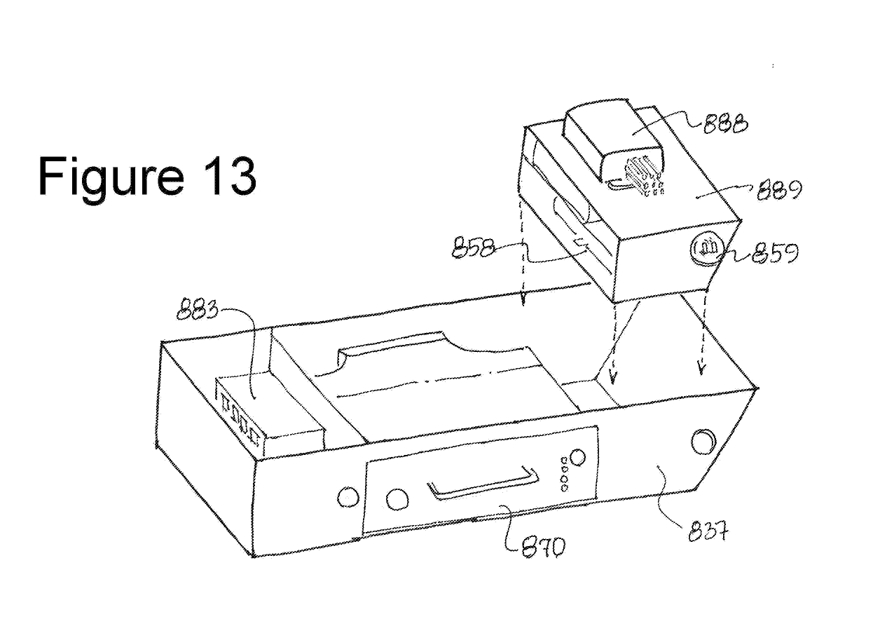

The batteries for the scooter may be charged by a battery charger. The charger type will be dictated by the voltage and amp hours of the batteries of the scooter system. The voltage may vary from 24, 36 and 48 volts. There may be an internally mounted battery charger (858 in FIG. 13). The internal battery charger 858 may be connected to a retractable extension cord 859. This allows the user to pull the male end out of the scooter and plug into any regular female 120 volt ac outlet, without carrying an external battery charger with them.

The internal battery charger 858 may also be connected to a regular female 120 volt a/c outlet 860 with a standard extension cord plugged into a male outlet mounted on the scooter. There may be a plurality of external charging devises available to charge the scooter batteries. Any external solar modules 12 used in conjunction with charging the battery(s) of the scooter may be plugged into a plurality of charge port plugs 862, including, but not limited to XLR plugs, multiple port house plugs, and multiple port inline plugs, or RC plugs. There may be a key lock switch 863 that allows the scooter to be operated when it is turned to the on position and disconnects the scooter controls when turned to the off position.

There may be one or more different battery systems 864 installed on the scooter. The battery system 864 may be comprised of sealed lead acid, SLA, batteries and come in various sizes, but not limited to 24, 36 and 48-volt systems as would be recognized to those skilled in the art.

The batteries may be wired in series in multiples of 12-volt batteries, to add up to various voltages, but not limited to 12, 24, 36, 48 volts or more. The batteries may be connected in series and in parallel to add up to the required voltage and amperage. The battery system 864 may be comprised of lithium ion batteries that come in various voltages. There may be many different types of batteries used on the scooter, by way of example, and not by way of limitation, sealed lead acid, lithium Ion and other types not yet in production.

As shown in FIG. 12, the battery systems 864 may comprise one or more removable battery modules 870 that are able to be removed from the scooter to allow the user to charge them in different locations. There may be numerous independent battery systems 864 or modules 870 installed on the scooter. The removability of the battery module 870 may allow, for example, a user to leave the scooter outside or in a garage, but take the battery module 870 up to his or her apartment or inside a house to plug into an outlet for overnight charging via the port plug 862 or the like.

There may be a switch 872 by which the scooter operator may choose which battery system receives electrical charging power at any particular time. The switch 872 may also be used to choose which battery system is supplying electrical power to the wheels at a particular time.

Electricity from the solar modules may be wired into the solar charge controller, solar regulator or trickle charge device (herein called a solar charge regulator), to charge the batteries. There are a vast plurality of options for SLA and Li-Ion battery charging. The scooter charging system may use a combination of the solar modules and ultra-capacitors to help in charging or storing energy for powering the scooter. Wind turbines may be mounted on the scooter and used to generate electricity when the scooter is in motion. This electricity may be used to charge the battery(s) on the scooter. An external solar electric module, wind electric, fuel cell or any other renewable energy source may be used to charge the scooter. Such devices may be plugged into a charge port on the scooter or directly into a removable battery.

Electric lights 887 may be mounted in various locations on the scooter. The lights may receive electrical power from the on board batteries or independent batteries.

With reference to FIG. 13, various components of an electrical system according to one embodiment are shown. There may be a plug-in charge controller 888 on the scooter to regulate the input when the batteries are being charged with 110-120 volt a/c power. An a/c module 889 containing the a/c plug-in charge controller 888, power cord 859, retractable cord reel, on-board charger 858 and associated wiring and circuitry may be removable for the scooter. The A/C module 889 may contain a plug on the aforementioned retractable extension cord for plugging the scooter in for wall charging while the batter module 870 is inserted into the scooter.

A solar charge controller 883 regulates input from the photovoltaic modules 12.

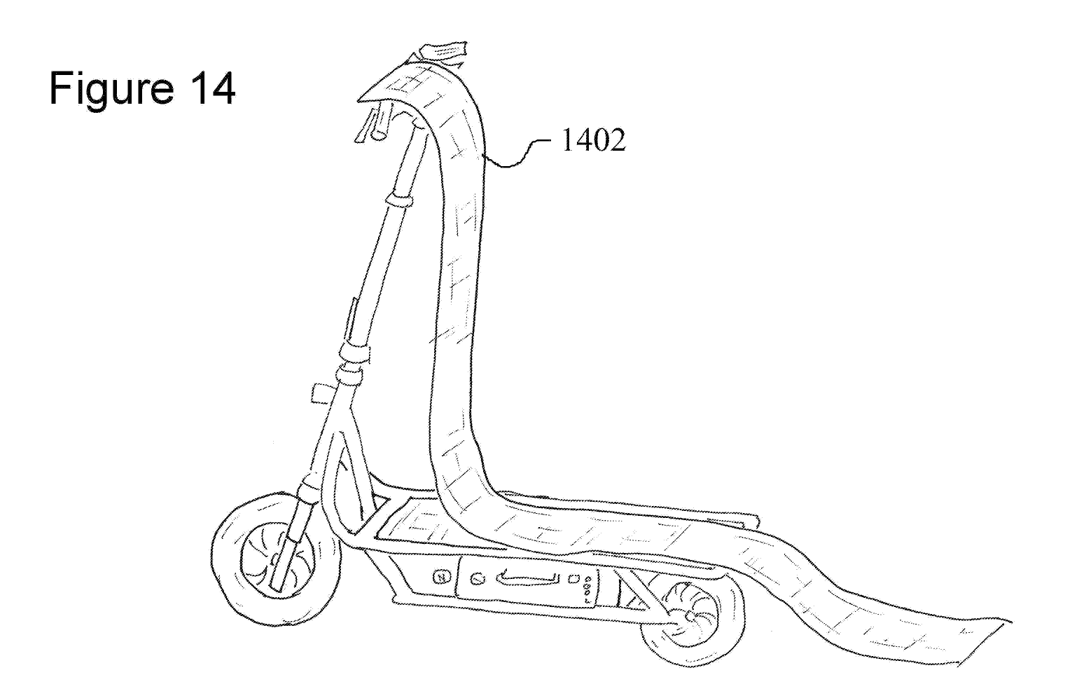

With reference to FIG. 14, a scooter according to the embodiment of FIG. 8 is shown but with an alternative roll-out solar cell module 1402 is shown. Roll-out solar cells are available from Solo Power, Inc. of San Jose, Calif., USA. In FIG. 14, the roll-out solar cell module 1402, made of thin film, may be positioned on top of the scooter. The roll-out solar cell module 1402 may provide solar charging instead of, or in addition to, the solar cells 42 on the upper deck 804, to provide for a larger surface area for charging. In one embodiment, the roll-out solar cell module 1402, when rolled up, may be stored under the upper deck 804. When rolled out for use, the roll-out solar cell module 1402 may be plugged into the solar charge controller 883.

The various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. An apparatus for transportation, comprising:
one or more removable battery modules capable receiving and storing an electric charge in one or more batteries;
an electric motor capable of providing rotational velocity to one or more wheels upon receiving power from the batteries;
one or more photovoltaic modules comprising solar cells capable of providing electric charge to the one or more batteries; and
a plug-in a/c adaptor capable charging the one or more removable battery modules.

2. The apparatus of claim 1, comprising a scooter, having a frame.

3. The apparatus of claim 2, wherein the photovoltaic modules form a deck on which an operator of the scooter can place feet when the photovoltaic modules are in a folded configuration.

4. The apparatus of claim 3, wherein the solar cells are capable of exposure to light radiation to charge the removable battery modules.

5. The apparatus of claim 4, the a/c adaptor is independently capable of providing charge to the removable battery modules while the removable battery modules are removed from the apparatus for transportation.

6. An apparatus for transportation, comprising:
one or more removable battery modules capable receiving and storing an electric charge;
an electric motor capable of providing rotational velocity to one or more wheels upon receiving power from the batteries;
one or more rollable photovoltaic modules comprising solar cells capable of providing electric charge to the one or more batteries; and
a plug-in a/c adaptor capable charging the one or more removable battery modules.

7. The apparatus of claim 18, wherein the rollable photovoltaic module is storable within the apparatus for transportation.
